(19) United States
(12) Patent Application Publication
(10) Pub. No.: US 2024/0417064 A1
(43) Pub. Date: Dec. 19, 2024

(54) AIRCRAFT SIDESTICK

(71) Applicant: Evgeny A. Nesmeev, Ulan-Ude (RU)

(72) Inventor: Evgeny A. Nesmeev, Ulan-Ude (RU)

(21) Appl. No.: 18/702,879

(22) PCT Filed: Jul. 27, 2022
(86) PCT No.: PCT/RU2022/000241

§ 371 Date: Apr. 19, 2024

(30) Foreign Application Priority Data
Oct. 27, 2021 (RU) 2021127270

(51) Int. Cl. B64C 13/04

(52) U.S. Cl. CPC B64C 13/0421

(57) ABSTRACT

An aviation sidestick is a device that can be used to control various manned and unmanned equipment, including flying, ground, underwater, to control spacecraft in outer space and to control computer games. It consists of a housing, a handle with buttons and a scroll wheel, a bracket/arm, a compensating mechanism, a fixed base in the form of a spherical segment and a mechanism that simulates feedback located under the compensating mechanism, while the geometric centers of the sphere and the focus of the sphere segment do not coincide, but is positioned on the same axis.

### FIELD OF THE INVENTION AND DESCRIPTION OF THE PRIOR ART

An aviation sidestick (hereinafter referred to as the device) is a device consisting of a body, a handle with programmable buttons and a scroll wheel; a fixed base and a mechanism are located under the fixed base. The device can be used to control various manned and unmanned equipment, including flying, ground, underwater, and to control spacecrafts in outer space. In addition, the device can be used to control computer games.

The device of the invention performs similar functions to the known joystick design, for example, as described in the patent U.S. Pat. No. 4,870,389A, as well as to the known sidestick designs described in the following patents: U.S. Pat. No. 5,149,023A, GB2484830A, U.S. Pat. No. 9,051,836B2, U.S. Pat. No. 9,056,675B2, U.S. Pat. No. 9,067,672B2, U.S. Pat. No. 9,405,312B2.

All these devices share several disadvantages/drawbacks that make it difficult to control the operation of such devices. Among such drawbacks are a large distance between the handle and the axis of rotation, as in the U.S. Pat. No. 5,149,023A patent; or an insufficient number of degrees of freedom, as in the U.S. Pat. No. 9,051,836B2 patent.

The closest prior art known to the inventor is Russian patent RU2730081. However, this design has a problem with the curvature of the supporting hemispherical base. This may result in difficulty scaling the design. That is, the smaller the hemispherical base is, the greater its curvature, which can make it difficult to use. On the other hand, the larger is the hemispherical base, the larger the bracket connecting the handle and the sphere should be. This may also make the device difficult to use.

### DESCRIPTION OF THE INVENTION ILLUSTRATED IN THE DRAWINGS

The design of the aviation sidestick of the invention is free of the above-noted shortcomings. The design of the invention is represented by the following figures:

FIG. 1 is a schematic cross-sectional view of the device of the invention, wherein:

1—handle with programmable keys and a scroll wheel (the keys and scroll wheel are not indicated in the figures, hereinafter-handle), 2—main bracket; 3—printed circuit board with electronic components (hereinafter-board); and 15—optical sensor; 4—sphere; 5—stepper motor; 6—threaded bushing; 7—solenoids with ball bearings (hereinafter-solenoids); 8—external cylinder; 9—internal cylinder; 10—bottom bracket, 11—device housing (hereinafter-housing), 12—sphere segment, 13—bracket mobility sector; 14—gap; 15—optical sensor; 16—screw; 21—solenoid core; 22—window for the solenoid; 31 partition; 33—main bracket window (hereinafter—window); 34—focus sphere segment; 35—common imaginary axis of the sphere and sphere segment (hereinafter-axis); 36—middle bracket and 37—bar.

Explanation: the center of the sphere is not indicated in the figures and it must be understood that it correspond to the geometric center of the sphere 4. The focus of the sphere segment 34 is the center of an imaginary sphere, a part of which is used to form the “sphere segment” figure.

FIG. 2 illustrates an exterior view of the device, wherein:

1—handle, 2—main bracket, 11—body, 12—sphere segment, 13—bracket mobility sector.

FIG. 3 depicts the following elements of the invention: 17—corrugated structure, 18—first electrical connector, 19—second electrical connector, 20—electrical wires (hereinafter-wires).

FIGS. 4, 5 and 6 show embodiments of a compensating mechanism for adjusting the gap 14.

FIG. 4 illustrates 5—stepper motor, 28—spur gear, 23—gear bar, 9—inner cylinder, 8—outer cylinder. Explanation: use of both straight and helical gears is in the scope of the invention.

FIG. 5 illustrates the following elements of the invention: 8—outer cylinder, 9—inner cylinder, 24—worm shaft, 25—guide groove, 30—threaded ring, 32—guide protrusion.

FIG. 6 illustrates the following elements of the invention: 5—stepper motor, 6—threaded bushing, 26—large gear, 9—inner cylinder, 8—outer cylinder, 29—small gear, 27—gear screw.

Referring now to FIG. 7 which represents a sectional view of the device, wherein the following elements of the invention are illustrated:

1 is a handle with programmable keys and a scroll wheel (the keys and scroll wheel are not indicated in the figures, hereinafter-the handle), 2 is the main bracket, 3 is a printed circuit board with electronic components (hereinafter-the board); 15 is an optical sensor, 4—a sphere, 5—a stepper motor, 6—a threaded bushing, 7—a solenoids with ball bearings (hereinafter: solenoids), 8—an outer cylinder, 9—an inner cylinder, 10—a bottom bracket, 11—a device body (hereinafter: housing), 12—a sphere segment, 13—a bracket mobility sector, 14—a gap, 15—an optical sensor, 16—a screw, 21—a solenoid core, 22—a window for the solenoid, 31—a partition, 33—a main bracket window (hereinafter: window), 34—a focus of the sphere segment, 35—a common imaginary axis of the sphere and sphere segment (hereinafter: axis), 36—a middle bracket, 37—a bar.

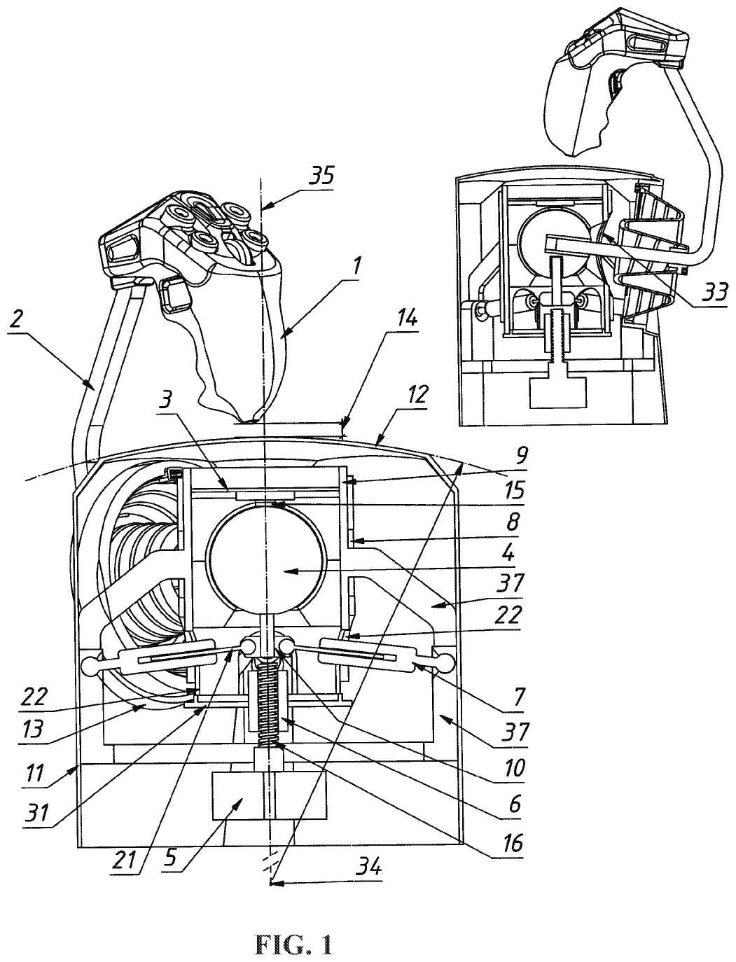

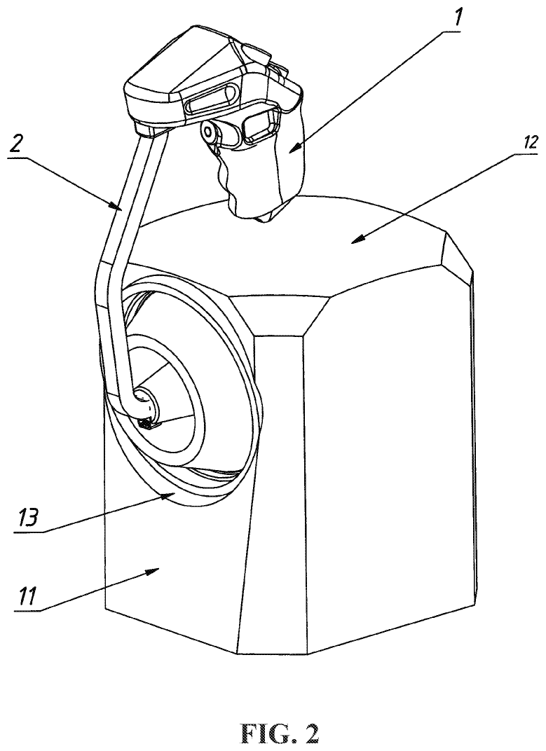

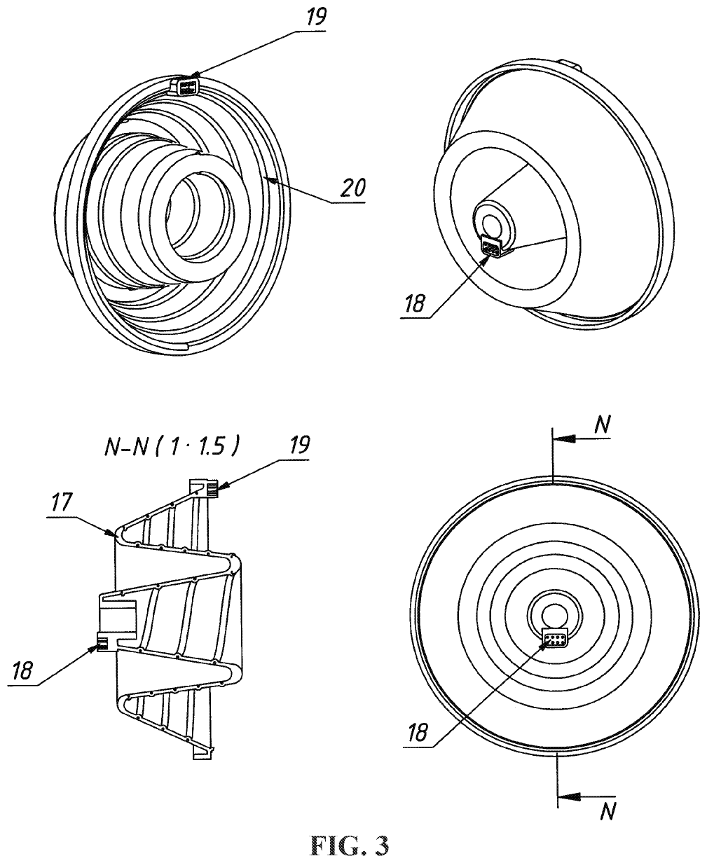

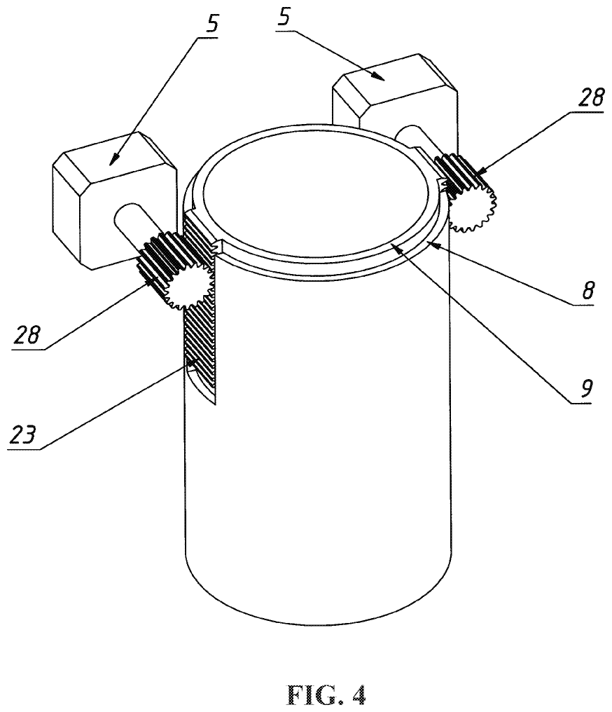

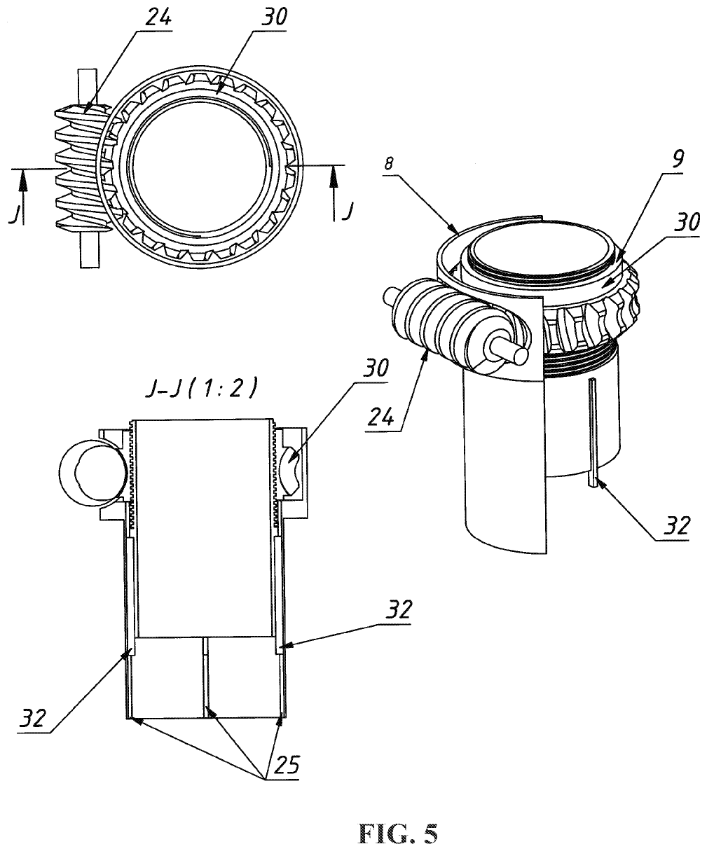

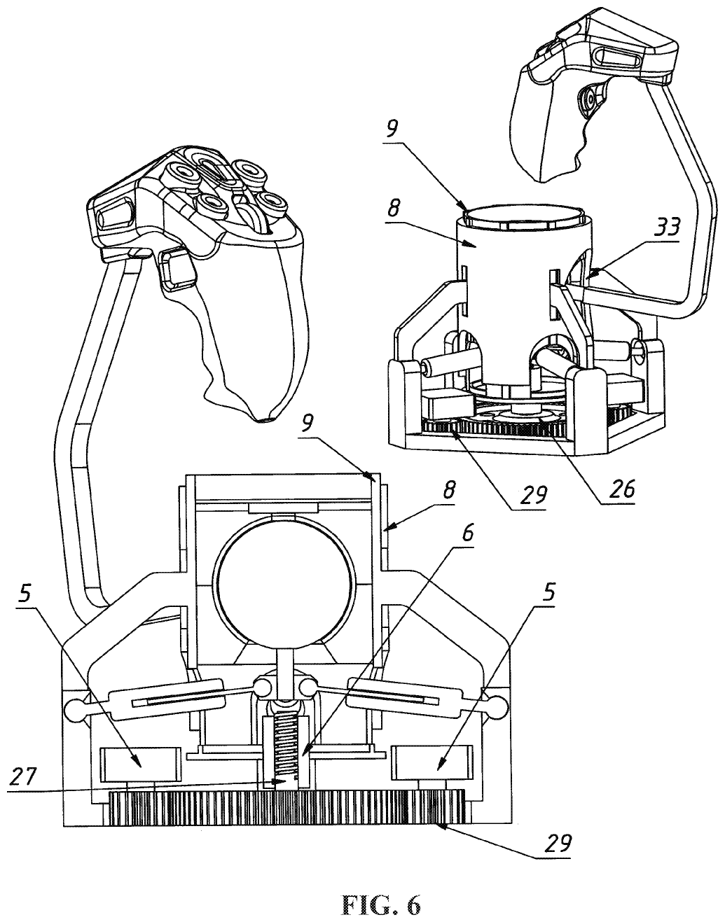

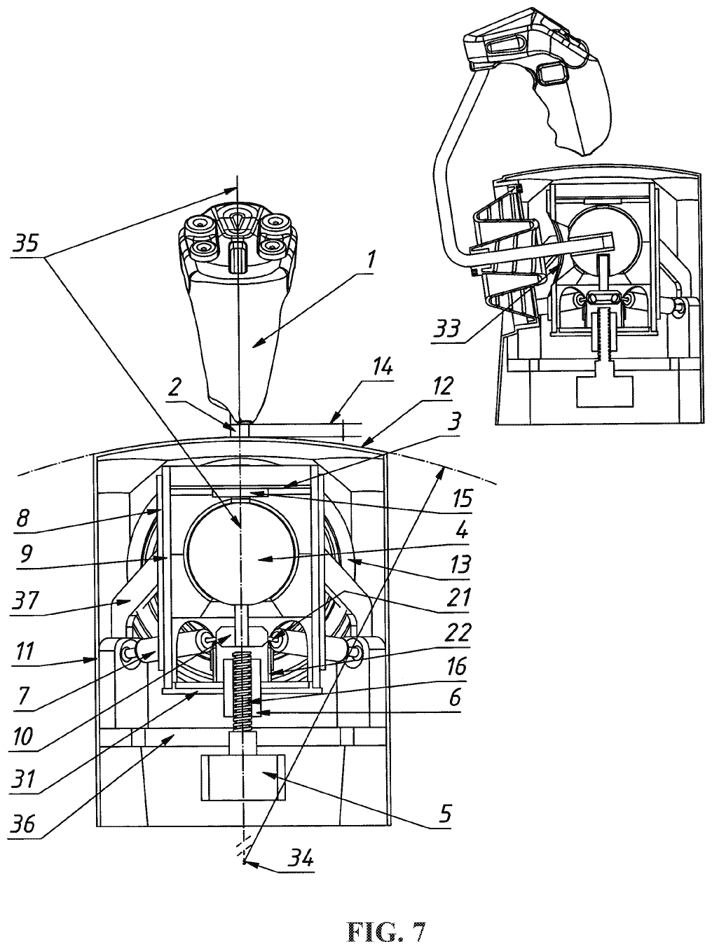

Referring now to FIG. 1 and FIG. 7 illustrating the device which consists of a housing 11, a handle 1, a main bracket 2 which can be formed having two parts, upper and lower (not indicated in the figures); a compensating mechanism is located inside the housing 11 provided to automatically adjusts the gap 14, the compensating mechanism consists of a stepper motor 5, a screw 16 and a threaded bushing 6, which serve to adjust the gap 14 by moving up or down the inner cylinder 9; as well as the board 3 located inside the cylinder 9 with an optical sensor 15 installed on the board; a sphere 4 on which the lower end of the main bracket 2 is fixed and the lower bracket 10 is also fixed, in which the solenoid cores 21 are secured using a ball joint.

The design also contains a screw 16, a threaded bushing 6, solenoids 7 secured by a ball joint on the middle bracket 36. Also, illustrated in FIG. 1 there is a gap 14 between the sphere segment 12 and the handle 1; the size of the gap can vary within the range from 4 to 15 mm, depending on the size of the user's hand.

There are also shown the following structural elements-the mobility sector of the bracket 13 in the form of a cutout in the sphere segment 12 and in the housing 1; the outer cylinder 8 is rigidly connected to the housing 1; a movable inner cylinder 9 is installed in the housing 1; the cylinder 9 is rigidly attached to the middle bracket 36 using strips 37.

In addition, when connecting using wires laid from the buttons (not indicated in the figures) handle 1 to the board 3 a corrugated structure 17 (FIG. 3) can be used; the sockets of which/corrugated structure 17 have built-in electrical connectors: the first electrical connector 18 and the second electrical connector 19, which are connected to each other by wires 20 laid in the body of the material used for manufacturing of the corrugated structure.

Each socket may include several electrical connectors, or the circumference of each socket may be in the form of a continuous connector. That is, the end of the wires coming out of the handle I may be provided with a connector (not shown). Such connector is connected to the first electrical connector 18 located on the bell of the corrugated structure 17, and the second electrical connector 19 is connected to the connector installed on the housing 11 (not shown). This assures a reliable contact between different parts of the electrical circuit through a flexible corrugated structure.

Referring now to FIGS. 4, 5 and 6 illustrating examples of the mechanism for moving the inner cylinder 9 used for adjusting the gap 14. FIG. 4 shows an embodiment of a mechanism with gear racks 23 installed on the sides of the inner cylinder 9, in the cutouts of the outer cylinder 8 (not indicated), wherein the gear racks 23 engage the spur gears 28 driven into rotation by the stepper motor 5. In this way, the inner cylinder 9 moves up or down.

FIG. 5 shows a mechanism for moving the inner cylinder 9 using a worm shaft 24, which rotates a threaded ring 30 embedded between the outer cylinder 8 and the inner cylinder 9, having threaded engagement with it. In this case, the inner cylinder 9 does not rotate due to the guide grooves 25 and guide protrusions 32.

FIG. 6 shows a mechanism for moving the inner cylinder 9 relative to the outer cylinder 8 using a large gear 26, a small gear 29, a stepper motor 5, a screw 16 and a bushing 6. In this version of the mechanism, both spur and helical gears can be used.

The aviation sidestick can be made for both the left and right hand of the user. This description presents a version of the device for the right hand.

In contrast with the design presented in the Russian patent RU2730081, the present design of the aircraft sidestick has significant differences and is free of its drawbacks, namely:

in the present design of the aircraft sidestick, the adjustment of the gap between the handle and the segment of the sphere 12 can be done either by using the main bracket 2 equipped, for such possibility with its own screw and a stepper motor, or equipped with a compensating mechanism installed in the body of the device. However, Figures of the present application show the design of an aircraft sidestick, wherein the regulation of the gap 14 is carried out only by a compensating mechanism.

Another essential feature which differentiates the invention over the prior art is the possibility of using a sphere segment 12 of a larger radius, without necessarily combining its focus of the sphere segment 34 and the center of the sphere 4 installed in cylinder 9. This is a major distinction over patent RU2730081, where the centers of the sphere and the hemispherical base must coincide. In the present invention the vertical coaxiality of the center of sphere 4 and the focus of the sphere segment 34 are maintained. Explanation: the hemispherical base is a term used in patent RU2730081.

The use of a sphere segment 12 having a large radius makes it possible to make its surface (intended to support the hand of the user holding the handle 1) more even. This significantly increases the ability of the invention to accurately control various equipment used with the device of the invention.

The aviation sidestick of the invention operates in the following manner: the user connects the device to a source of electrical power; wherein the computing device, guided by the respective program sends electronic signals to the stepper motor of the compensating mechanism and to the solenoids of the feedback mechanism. These elements of the invention set the handle 1 to the desired height above the segment of the sphere 12 to the position at the origin of coordinates, which may be located in the center of the sphere segment 12 or at another place, depending on the settings. Then, the user by holding the handle 1 with the edge of a bent palm, touches the segment of the sphere 12 (which is made of a slippery material). Sliding motion of the edge of the user's palm, when moving the handle 1, is carried out due to the gap 14. This gap should remain unchanged at any part of the segment of the sphere 12. In this case, in view to the window 33, the main bracket 2 connects the handle 1 and the sphere 4 located in the inner cylinder 9.

Moreover, the center of the sphere 4 and the focus of the sphere segment 34, as well as their radii do not coincide and are located at the same axis 35. However, the user, whose palm edge touches the sphere segment 12 when moving the handle, does not feel any discomfort. This is due to the decrease or increase of the gap 14. Such a result is achieved in view of a compensating mechanism located inside housing 11.

The compensation mechanism operates in the following manner. The outer cylinder 8 is rigidly fixed in the housing 11. In the interior of the cylinder 8 there is an inner cylinder 9 containing a sphere 4, a bottom bracket 10 and a board 3 with an optical sensor 15. The inner cylinder 9 is in sliding contact with the outer cylinder 8, wherein the guide grooves 25 and the guide protrusions 32 protect the inner cylinder 9 from turning.

The bottom side of the inner cylinder 9 has a partition 31 on which a threaded sleeve 6 is installed. Such sleeve has a threaded connection with the screw 16 of the stepper motor 5. When moving the handle 1, the optical sensor 15 located on the board 3 receives information from the surface of the sphere 4 and transmits such information to the board 3 where the computing unit is located. The computing unit, in accordance with the software algorithm, determines the angle, speed and direction of rotation of the sphere 4 relative to the optical sensor 15.

The computing unit, based on the received data and the software, sends signals to the stepper motor 5. By rotating the screw 16 the stepper motor 5 moves the internal cylinder 9 up or down along with the structural elements located in it with the middle bracket 36 fixed on it using strips 37. Thus, introducing amendments to the changing gap 14 between the handle 1 and the sphere segment 12.

It should be noted that when moving the handle 1, with the compensating mechanism not working, the gap 14 will change. This is because the center of the sphere 4 and the focus of the sphere segment 34 do not coincide. Below the sphere 4 there are solenoids 7 and solenoid cores 21, which serve to simulate sidestick feedback with the control surfaces of the aircraft, to which the aircraft's computing device (not shown) supplies an electrical voltage that it changes depending on the software and flight conditions.

That is, the compensating mechanism, due to the rigid fixation to the inner cylinder 9, also carries almost the entire mechanism for simulating feedback, including solenoids 7, bars 37, middle bracket 36. The solenoid cores 21 are connected to sphere 4 by means of the bottom bracket 10, having a ball joint therebetween.

The solenoid cores are installed in solenoids 7, which also have a ball joint with the middle bracket 36. For the operation of solenoids 7, in the inner cylinder 9 there are provided windows for solenoids 22. Thus, board 3, optical sensor 15, sphere 4, solenoids 7, solenoid cores 21, the inner cylinder 9 and the middle bracket 36 attached represent elements of the movable compensating mechanism.

However, an embodiment of the design of the compensating mechanism is possible, wherein the strips 37 and the middle bracket 36 are absent, and the solenoids 7 have a ball joint with a static body 11. This embodiment is possible by using software capable of taking into account the operation of the solenoids without reference to the coordinate system of the compensating mechanism. In this arrangement when the compensating mechanism moves up or down, each of the solenoids 7 will work in its own coordinate system.

This principle can also be applied to adjust the gap 14 in an aircraft sidestick design where the center of the sphere 4 and the focus of the sphere segment 34 coincide (as in U.S. Pat. No. 2,730,081). In this option, before starting to use the sidestick, the user himself can adjust the gap 14. This might occur for example: by rotating the potentiometer, or before starting to use the sidestick, the user connects to it a flash card with information contained on it about the size of the user's hand, which was saved earlier during setup devices.

Information from the flash card is transferred to the computing unit, and after that the device itself, based on the received data and using a stepper motor compensating mechanism, sets the necessary parameters by moving the internal cylinder 9 up or down.

To reduce the height of the device, it is possible to use the mechanism shown in FIG. 4. Such mechanism is provided for moving the inner cylinder 9 for adjustment of the gap 14. This occurs by using stepper motors installed in the windows (not shown) of the outer cylinder 8 and gear racks 23, having a rigid connection with the inner cylinder 9, while utilizing stepper motors driving into rotation spur gears 28.

Referring now to FIG. 5 illustrating another embodiment of the method of the invention for moving the inner cylinder 9 up or down. This enables the invention to adjust the gap 14 using a threaded ring 30 having a screw connection with the inner cylinder 9 and threads (not shown) on the outside for engagement with the worm shaft 24 driven by the stepper motor 5.

When the worm shaft 24 rotates, by means of a screw connection the threaded ring 30 is driven. Such ring 30 using a screw connection with the inner cylinder 9, moves it up or down, depending on the rotational direction the of the worm shaft 24.

Referring now to FIG. 6 which illustrates a mechanism for moving the inner cylinder 9 to adjust the gap 14; wherein the stepper motor 5 through a small gear 29 rotates a large gear 26 installed below the cylinder 9. The large gear 26 is connected to the cylinder 9 using a threaded bushing 6 and a gear screw 27.

In this embodiment of the mechanism of the invention (as well as the embodiments shown in FIG. 5 and FIG. 6), the design of the aircraft sidestick may include several stepper motors. Also in this embodiment, instead of the large gear 29, a bevel gear (not shown in the figures) can be used, kinematically connected at an angle to another bevel gear driven from a stepper motor.

In addition, in the drive of the compensating mechanism, to regulate the gap 14, instead of gears, toothed belts and toothed pulleys (not shown in the figures) can be utilized.

Thus, there are several ways to adjust the gap 14 when the center of the sphere 4 and the focus of the segment of the sphere 34 of the device do not coincide.

Although the drawings illustrate the aircraft sidestick with the front location of the main bracket 2, however it should be noted that the positioning of the main bracket on the right or left side of the device handle is also in the scope of the invention.

1. An aviation sidestick comprising:
a body, a handle with buttons and a scroll wheel, a height-adjustable bracket, a sphere, a computing device, an optical sensor and a stationary segment of the sphere,
wherein a mechanism that simulates feedback is located under a base;
wherein a center of the sphere, a focus of a sphere segment and radii of the spheres do not coincide and are located at a common imaginary axis;
wherein a compensating mechanism is located inside the body, the compensating mechanism consists of a fixed outer cylinder and a movable inner cylinder, a screw and a threaded bushing, a stepper motor, as well as gears and racks or a worm shaft and a rotary threaded ring, or a gear and a small gear, or toothed pulleys and toothed belts;
wherein the aircraft sidestick contains a corrugated structure with electrical connectors placed on its bells, interconnected by electrical wires laid in the body of its material, and the middle bracket and
wherein the feedback mechanism is rigidly connected to the compensating mechanism.
